(19) United States
(12) Patent Application Publication
(10) Pub. No.: US 2002/0004908 A1
(43) Pub. Date: Jan. 10, 2002

(54) Electronic mail message anti-virus system and method

(75) Inventor: Nicholas Paul Andrew Galea, Iklin (MT)

Correspondence Address: Ladas & Parry, 26 West 61st Street, New York, NY, 10023, US

(73) Assignee: NICHOLAS PAUL ANDREW GALEA

(21) Appl. No.: 09/812,409

(22) Filed: Mar. 20, 2001

(30) Foreign Application Priority Data
Jul. 5, 2000 (GB) 0016553.0

(51) Int. Cl. G06F 11/30; H04L 9/00

(52) U.S. Cl. 713/200; 713/188

(57) ABSTRACT

An anti-virus system for electronic mail messages having detection means for determining the presence of an electronic mail message and analyzing and scanning means for detecting in the electronic mail message any tags indicating the presence of operable program code, such tags and operable code are removed from the electronic message before the message is delivered to the intended recipient. Means may also be provided for separately scanning the body and attachments of the message and for quarantining either body text or an attachment that is found to contain operable code until a decision is made whether the operable code should be deleted.

### BACKGROUND OF THE INVENTION

1) Field of the Invention

This invention relates to an electronic mail message anti-virus system and method.

2) Description of the Related Art

Computers and computer networks are susceptible to attack from an HTML electronic mail message that contains a malicious code or the ability to trigger a program that could damage the computer system upon receipt of the electronic mail message. Anti-virus systems have been developed to detect such viruses which would otherwise infect a computer. Versions of anti-virus systems are known for detecting viruses transmitted by electronic mail. However, known anti-virus systems have been largely unsuccessful in combating viruses delivered by electronic mail for a number of reasons. First, known systems can only protect against known viruses. This may be done by scanning an incoming electronic mail message for strings of characters which are known to be included in known viruses. However, because such systems can only protect against known viruses and since electronic mail can spread viruses in a matter of hours, such systems are completely ineffective against electronic mail viruses as the anti-virus system cannot be updated with strings associated with the new virus before the computer is infected. Another problem with conventional electronic mail virus detection is that not all viruses are widespread. A virus may be created against a particular company, to obtain particular information from that company, for example, for industrial espionage. In that case, no measures can be taken to protect the system from the virus because the virus is not known until after the attack has occurred. Another problem with conventional anti-virus systems is that they scan only the attachment of an electronic mail message and not the electronic mail body itself. However, electronic mail viruses may not only be contained in attachments but may be contained in the message body itself, in which case, a virus can be activated without the user opening an electronic mail attachment.

It is an object of the present invention to provide an anti-virus system and method which substantially overcome these limitations.

### SUMMARY OF THE INVENTION

According to the present invention there is provided an anti-virus system for an electronic mail message, the system including means for determining the presence of the electronic mail message; means for analysing and scanning the electronic mail message for tags indicating the presence of operable program code and for removing any such tags and operable program code from the electronic mail message; and means for applying the electronic mail message with the tags and operable program code removed to server means.

Preferably, the means for determining the presence of the electronic mail message includes means for breaking the message into constituent bodies or message texts and attachments of the electronic message; the means for analysing and scanning comprises means for scanning the constituent bodies and attachments and the means for applying the electronic mail message with the tags and operable program code removed to server means includes means for rebuilding the electronic message from the constituent bodies and attachments.

Conveniently, the means for analysing and scanning comprises means for scanning the message for predetermined character strings.

Advantageously, the means for applying the electronic mail message with the tags and operable program code removed to server means includes means for replacing the removed tag and operable program code with alternative text.

Preferably the alternative text is adapted to inform a recipient of the message that operable program code has been removed

Advantageously the means for analysing and scanning includes means for scanning attachments for operable macros.

Advantageously the system further comprises quarantine means for quarantining a constituent body containing operable program code and/or removing from the message and quarantining an attachment containing a macro.

Preferably the quarantine means includes means for removing a macro from an attachment, quarantining the macro and releasing the attachment with the macro removed.

Preferably the quarantine means includes means for storing the body, attachment or macro in a quarantine storage location as a quarantined item; means for receiving a input indicating a decision whether the quarantined item may be delivered to an intended recipient; and dependant on the decision input either releasing the quarantined item for delivery to the intended recipient or deleting the quarantined item.

Conveniently, the quarantine means includes means, on deleting the quarantined item, for informing the intended recipient and/or a sender of the message that the quarantined item has been deleted without being delivered to the intended recipient.

Conveniently the means for scanning attachments for operable macros comprises means for sequentially scanning the attachments for a plurality of predetermined character strings.

Preferably, the means for scanning attachments for a plurality of predetermined character strings includes means for terminating scanning when one of the predetermined strings is not found on completely scanning the attachment.

Conveniently, the means for determining the presence of the electronic mail message is adapted to capture all electronic mail messages passing between a first network and a second network.

Advantageously, the means for determining the presence of the electronic mail message is adapted to capture all electronic mail messages passing between an internal or private network and an external or public network.

According to a second aspect of the present invention there is provided a method of removing a virus from an electronic mail message including the steps of (a) capturing the message; (b) scanning the message for tags indicating the presence of operable program code; (c) removing the tags and operable program code from the electronic mail message; and (d) releasing the electronic mail message with the tags and operable program code removed.

Alternatively, step (c) comprises quarantining a message or a part of a message containing operable program code.

Preferably step (a) includes the step of breaking the message into constituent bodies or message texts and attachments of the electronic message; step (b) comprises scanning the constituent bodies and attachments and step (d) includes the step of rebuilding the electronic message from the constituent bodies and attachments.

Conveniently step (b) comprises scanning the message for predetermined character strings.

Advantageously step (c) includes replacing the removed tag and operable program code with alternative text.

Preferably the alternative text is adapted to inform a recipient of the message that operable program code has been removed.

Advantageously step (b) includes scanning attachments for operable macros and step (c) comprises removing from the message and quarantining any macros or, alternatively, any attachments containing macros.

Preferably the step of quarantining a constituent body, attachment or macro comprises the steps of: storing the constituent body, attachment or macro in a quarantine storage location as a quarantined item; receiving a decision whether the quarantined item may be delivered to an intended recipient; and dependant on the decision either releasing the quarantined item for delivery to the intended recipient or deleting the quarantined item

Conveniently, the step of deleting the quarantined item includes informing the intended recipient and/or a sender of the message that the quarantined item has been deleted without being delivered to the intended recipient.

Conveniently the step of scanning attachments for operable macros includes sequentially scanning the attachments for a plurality of predetermined character strings.

Preferably, the step of scanning attachments for a plurality of predetermined character strings is terminated when one of the predetermined strings is not found on completely scanning the attachment.

Conveniently, step (a) comprises capturing all electronic mail messages passing between a first network and a second network.

Advantageously, step (a) comprises capturing all electronic mail messages passing between an internal or private network and an external or public network.

According to a third aspect of the invention, there is provided a computer program comprising code means for performing all the steps of the method described above when the program is run on one or more computers.

Conveniently the computer program is embodied on a computer-readable medium.

According to a fourth aspect of the present invention, there is provided a computer program product comprising program code means stored in a computer-readable medium for performing the method described above when that program product is run on one or more computers.

An advantage of the present invention is that it does not seek to determine whether program coding included with an electronic message is malicious or not, but removes the capability of such an electronic mail message to execute the program or commands. That is, all electronic mail messages scanned that contain program code or instructions to run programs, are re-written in such a way that this capability is removed from the electronic mail message, or the message or part of the message containing the operable code is quarantined. This secures the recipient against all current, future and one-off viruses.

### BRIEF DESCRIPTION OF THE DRAWINGS

A specific embodiment of the invention will now be described by way of example, with reference to accompanying drawings, in which:

FIG. 1 shows a flowchart of a method, according to the present invention, of removing operable program code from a body or attachment of an electronic mail message;

FIG. 2 shows a flowchart of a method according to the invention of removing macros or attachments which contain macros from an electronic mail message;

FIG. 3 shows a flowchart of steps of the method of FIG. 2 for determining whether an electronic mail message contains a Microsoft Word™ macro;

FIG. 4 shows a flowchart of steps of the method of FIG. 2 for determining whether an electronic mail message contains a Microsoft Excel macro™ ;

FIG. 5 shows a block diagram of building blocks used in the method of the invention;

FIG. 6 shows the flow of electronic mail messages through a computer system employing the method of FIGS. 1 & 2; and

FIG. 7 shows steps in quarantining attachments of the method of FIG. 2.

In the drawings, like numerals denote like steps.

### DESCRIPTION OF THE PREFERRED EMBODIMENTS

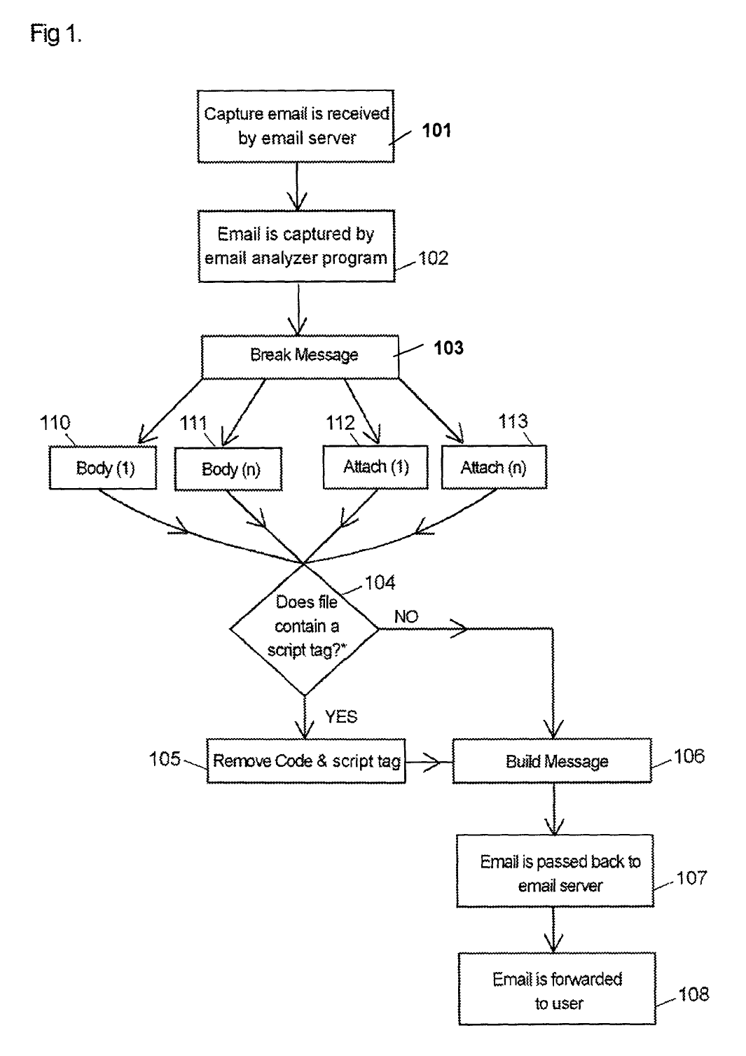

FIG. 1 illustrates an application of the invention in which the method of the invention is used in a gateway or electronic mail server, between a user's network and a public network, for example. However, it will be appreciated that the invention may be used to protect a single computer. As illustrated in FIG. 1, an electronic message received by the electronic mail server, step 101, is isolated, or captured, step 102. The captured electronic mail message is divided up, step 103, into its constituent bodies of message text 110, 111 and attachments 112, 113. An electronic mail message can have multiple bodies, also known as message text, and multiple attachments, but only two of each are illustrated in FIG. 1. The bodies and attachments are sequentially scanned, step 104, to determine whether any of the said bodies or attachments contains a character string indicating the presence of operable program code. That is, the program scans the body or attachment for a tag or tags which identify program code that will be run on viewing the electronic mail message or code that will run an external program executed once the electronic mail message is viewed. For example, in the current version of HTML the tag “scripts” identifies program code. The presence of such a tag means that an electronic mail message can potentially run an external program or trigger a program. It will be understood that for future or different versions of HTML, there may be more or different names for identifying script code. However, amending the method at step 104 to scan for such different character scripts is a trivial task compared with the impossibility of updating known anti-virus systems with character strings from all viruses in advance. If a script tag is found in an embodiment or attachment, the program is removed, step 105, from the body or attachment and preferably replaced with replacement text. Such replacement text may indicate to the eventual recipient of the electronic mail message that operable code has been removed. The electronic mail message is reassembled, step 106, by the electronic mail analyser program, that is, the electronic mail message is reconstituted from the separate bodies and the attachments reattached so the electronic mail message is recreated. The electronic mail message is passed, at step 107, back to the electronic mail server for forwarding, step 108, to the intended recipient. The intended recipient, therefore, receives a cleaned electronic mail message, which has no capability of running any programs and is, therefore, completely secure. Alternatively, the message containing script tag may be quarantined until subsequently released or deleted.

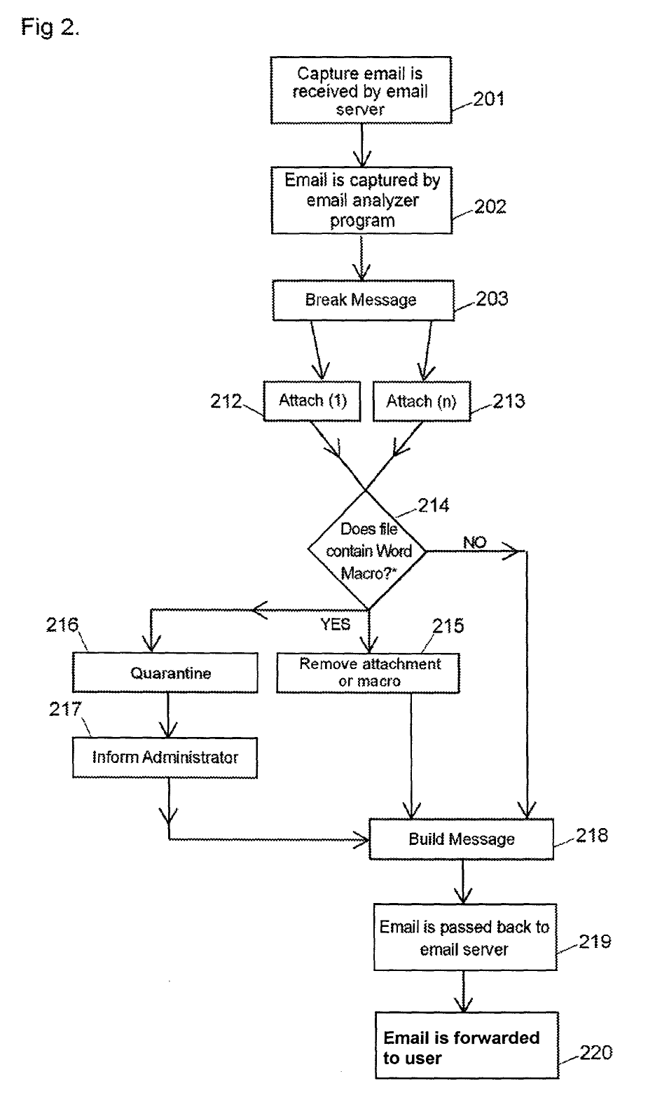

Simultaneously, or sequentially, the attachments are scanned to determine the presence of macros, as illustrated in FIG. 2. As already described in relation to FIG. 1, incoming or outgoing electronic mail messages are received by the electronic mail server, step 201, and an electronic mail message is isolated, step 202, and any attachments 212,213 are removed, step 203, from the electronic mail message and sequentially scanned to determine whether the attachments contain macros, step 214. If a macro is detected within an attachment, the attachment may either be deleted, step 215, or quarantined, step 216. Alternatively, the macro may be quarantined and the attachment released with the macro removed. If the macro or attachment is quarantined, a decision will subsequently be made, step 217, whether the macro or attachment should be deleted, or reassembled and reattached to the electronic mail message, step 218, or forwarded by other means to the intended recipient. If no macros are found in the attachment, then the attachment is reattached to the electronic mail message, step 218, and the electronic mail message is passed back to the electronic mail server, step 219, for forwarding, step 220, to the intended recipient. If an attachment has been deleted then a new attachment may be attached to the electronic mail message indicating to the intended recipient that the original attachment has been removed. In this manner, the method of the invention automatically removes any attachments from an electronic mail message which have the capability of running program codes or external programs by using macros. That is, all macros or attachments containing macros are removed and deleted, or at least quarantined, whether they are harmful or not.

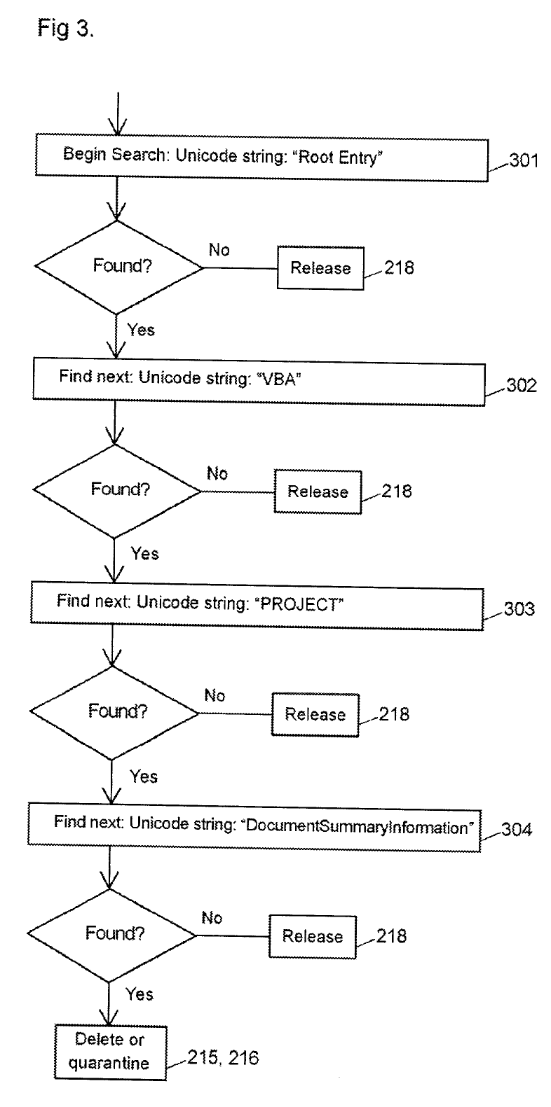

As shown in FIG. 3, if, for example, the analyser determines that an attachment is a Microsoft Word™ document, the attachment is searched sequentially for a number of character strings, thus the attachment is initially searched, step 301, for the character string “Root Entry”. If the character string is not found, it is thereby determined that the attachment does not contain a macro and the attachment is released for rebuilding the message, step 218 If, however, the string is found, the attachment is rescanned, step 302, for string “VBA” and as in the previous step, if the string is not found, the attachment is released, otherwise the attachment is rescanned sequentially in the same manner for the string “PROJECT”, step 303, and “DocumentSummaryInformation”, step 304. If the attachment is found to contain all four of the strings, the attachment is either deleted, step 215, or quarantined, step 216.

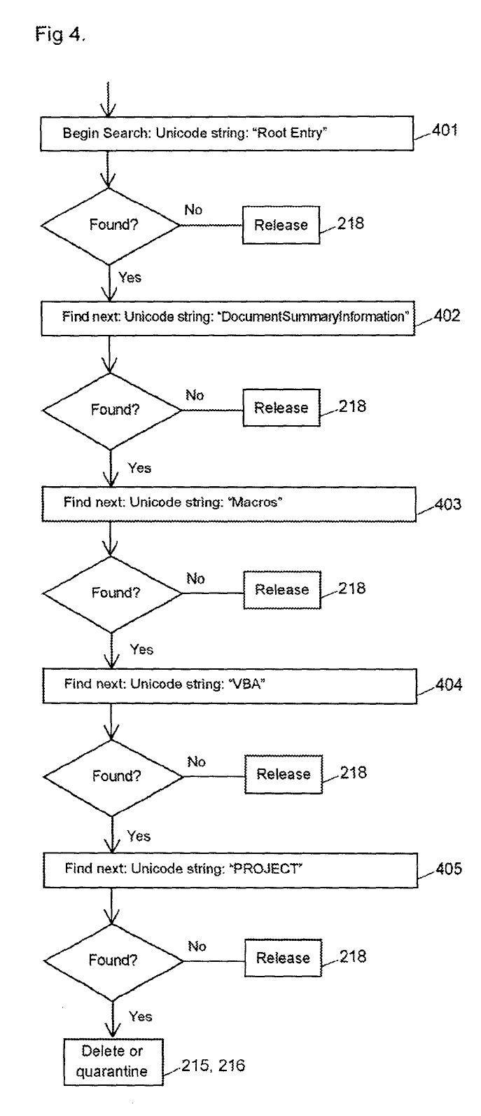

Similarly, FIG. 4 shows the procedure where the analysing program determines that the attachment is a Microsoft Excel™ document, in which the attachment is sequentially tested for the strings “Root Entry”, “DocumentSummaryInformation”, “Macros”, “NIBA” and “PROJECT”, steps 401-405. Once again, if the attachment is found to contain all five of these strings, it is determined that the attachment contains a macro and the attachment is either deleted, step 215, or quarantined, step 216. Alternatively, just the macro may be detached and quarantined. It will be appreciated that if other known types of documents are detected they may be scanned in similar ways for appropriate character strings.

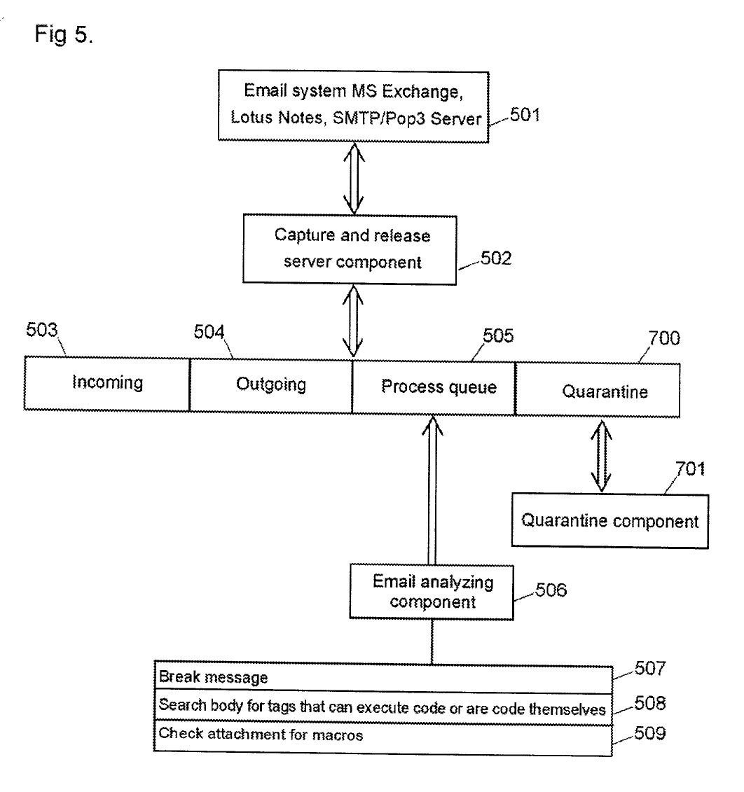

A block diagram of building blocks used in the method of the invention is shown in FIG. 5. A capture and release server component 502 transports mail into and out of the analysing system. The server component interfaces with an external mailing system 501, such as Microsoft Exchange Server, Lotus Notes or SMT/POP 3 servers. This server component interface enables the electronic mail analyser to capture all incoming and outgoing mail and places incoming mail 503 and outgoing mail 504, in a process queue 505. An electronic mail analysing component 506 analyses electronic mail messages from the processing queue 505 sequentially. This electronic mail analysing component consists of a backbone which controls a number of smaller modules which perform specific actions on the electronic mail message, such as a module for breaking the message into parts 507, a module for searching for character strings or keywords 508 that identify program code and a module for checking attachments for macros 509. These so-called plug-in modules provide all the electronic mail processing intelligence to the system, and the backbone manages the message process queue. The electronic mail analyser therefore submits each of the electronic mail messages to the plug-ins in turn. In addition to those already described, there may be additional plug-ins for decrypting the message body as well as, for example, checking the message content. Once an electronic mail message has been processed by all the plug-ins, the electronic mail analyser returns the message to the capture and release server component which releases a virus-free message to the external mailing system for delivery to the intended recipient.

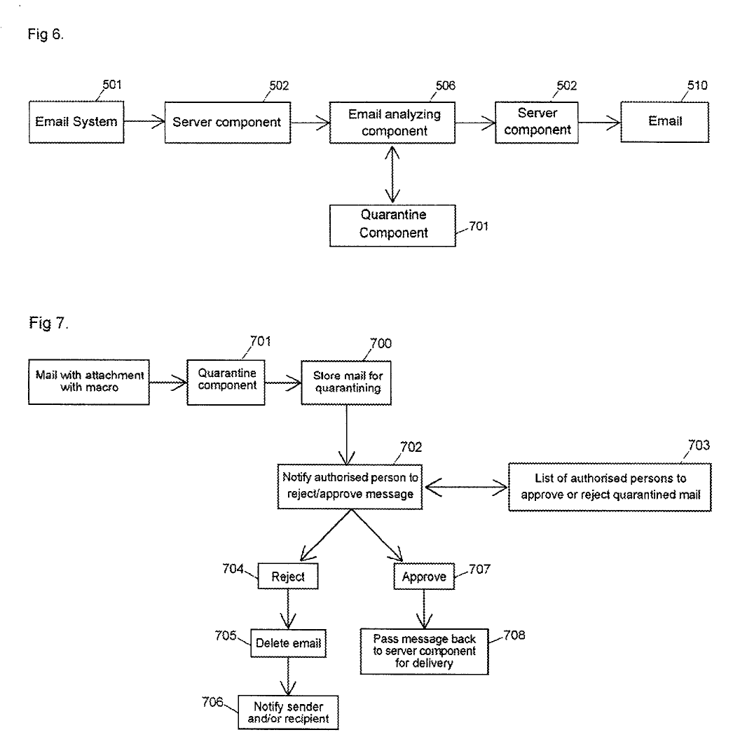

As shown in FIG. 6, the electronic mail analysing component, 506, is a central part of the overall system and a capture and release server component 502, both passes electronic mail message from an external electronic mail system 501 to the electronic mail analysing component 506, and after processing, the server component 502 passes an electronic mail message 510 back to the electronic mail system.

In certain circumstances a user may, for example, wish to be able to receive electronic mail attachments containing macros from, for example, particular known users. It will be understood that user settings may be stored in the electronic mail analysing component, 506 to specify whether embedded HTML scripts and macros are to be removed from all electronic mail messages or whether exceptions are to be made for messages received from or sent to particular users. In such a situation, the system would first check whether user settings exist for the particular sender and recipient of a captured message and if so the user settings would be applied and if not, default settings would be used.

As best shown in FIG. 7, an electronic mail message having program code, or attachments having program code or containing macros, is passed by a quarantine component 701 into quarantine 700. The quarantined message or message component is held while an authorised person is notified 702 to reject or approve the message, the authorised person being chosen from a list 703 of persons qualified to approve or reject quarantined mail. Dependent on the decision made, the quarantined message may be rejected, step 704, and deleted, step 705, in which case, optionally, the sender and/or recipient may be notified 706 that the message or message or component has been deleted. Alternatively, step 707, the quarantined message is approved and the message or component passed back to the server component, step 70S, for delivery to the intended recipient.

We claim:

1. An anti-virus system for an electronic mail message, the system including detecting means for determining the presence of the electronic mail message; analysis and scanning detecting means for analysing and scanning the electronic mail message for tags indicating the presence of operable program code and for removing any such tags and operable program code from the electronic mail message; and application means for applying the electronic mail message, with the tags and operable program code removed, to server means.

2. An anti-virus system as claimed in claim 1, wherein the detecting means for determining the presence of the electronic mail message includes decomposition means for breaking the message into constituent bodies or message texts and attachments of the electronic message; the analysis and scanning means comprise scanning means for scanning the constituent bodies and attachments and the application means for applying the electronic mail message with the tags and operable program code removed to server means includes recomposition means for rebuilding the electronic message from the constituent bodies and attachments.

3. An anti-virus system as claimed in claim 1, wherein the analysis and scanning means comprise scanning means for scanning the message for predetermined character strings.

4. An anti-virus system as claimed in claim 1, wherein the application means for applying the electronic mail message with the tags and operable program code removed to server means includes replacement means for replacing the removed tag and operable program code with alternative text.

5. An anti-virus system as claimed in claim 4, wherein the replacement means is adapted to replace with alternative text for informing a recipient of the message that operable program code has been removed.

6. An anti-virus system as claimed in claim 2, wherein the analysis and scanning means include scanning means for scanning attachments for operable macros.

7. An anti-virus system as claimed in claim 2, wherein the system further comprises quarantine means for quarantining a constituent body containing operable program code and/or removing from the message and quarantining an attachment containing a macro or operable program code.

8. An anti-virus system as claimed in claim 7, wherein the quarantine means includes means for removing a macro from an attachment, quarantining the macro and releasing the attachment with the macro removed.

9. An anti-virus system as claimed in claim 7, wherein the quarantine means includes means for storing the constituent body, attachment or macro in a quarantine storage location as a quarantined item; receiving means for receiving a input indicating a decision whether the quarantined item may be delivered to an intended recipient; and dependant on the decision input either releasing the quarantined item for delivery to the intended recipient with or without the operable code removed or deleting the quarantined item.

10. An anti-virus system as claimed in claim 7, wherein the quarantine means includes informing means, on deleting the quarantined item, for informing the intended recipient and/or a sender of the message that the quarantined item has been deleted without being delivered to the intended recipient.

11. An anti-virus system as claimed in claim 6, wherein the scanning means for scanning attachments for operable macros comprises means for sequentially scanning the attachments for a plurality of predetermined character strings.

12. An anti-virus system as claimed in claim 11, wherein the means for scanning attachments for a plurality of predetermined character strings includes termination means for terminating scanning when one of the predetermined strings is not found on completely scanning the attachment.

13. An anti-virus system as claimed in claim 1, wherein the detecting means for determining the presence of the electronic mail message is adapted to capture electronic mail messages passing between a first network and a second network.

14. An anti-virus system as claimed in claim 13, wherein the detecting means for determining the presence of the electronic mail message is adapted to capture electronic mail messages passing between an internal or private network and an external or public network.

15. A method for removing a virus from an electronic mail message including the steps of (a) capturing the message; (b) scanning the message for tags indicating the presence of operable program code; (c) removing the tags and operable program code from the electronic mail message; and (d) releasing the electronic mail message with the tags and operable program code removed.

16. A method as claimed in claim 15, wherein step (c) comprises quarantining a message or a part of a message containing operable program code.

17. A method as claimed in claim 15, wherein step (a) includes the step of breaking the message into constituent bodies or message texts and attachments of the electronic message; step (b) comprises scanning the constituent bodies and attachments and step (d) includes the step of rebuilding the electronic message from the constituent bodies and attachments.

18. A method as claimed in claim 15, wherein step (b) comprises scanning the message for predetermined character strings.

19. A method as claimed in claim 15, wherein step (c) includes replacing the removed tag and operable program code with alternative text.

20. A method a claimed in claim 19, wherein the step of replacing the removed tag and operable code with alternative text comprises using alternative text for informing a recipient of the message that operable program code has been removed.

21. A method as claimed in claim 17, wherein step (b) includes scanning attachments for operable macros and step (c) comprises removing from the message and quarantining any macros and/or any attachments containing macros.

22. A method as claimed in claim 16, wherein the step of quarantining a message or a part of a message comprises the steps of: storing a constituent body, attachment or macro of the message in a quarantine storage location as a quarantined item; receiving a decision whether the quarantined item may be delivered to an intended recipient; and dependant on the decision either releasing the quarantined item for delivery, with or without the operable code or macro deleted, to the intended recipient or deleting the quarantined item.

23. A method as claimed in claim 22, wherein the step of deleting the quarantined item includes informing the intended recipient and/or a sender of the message that the quarantined item has been deleted without being delivered to the intended recipient.

24. A method as claimed in claims 21, wherein the step of scanning attachments for operable macros includes sequentially scanning the attachments for a plurality of predetermined character strings.

25. A method as claimed in claim 24, wherein the step of scanning attachments for a plurality of predetermined character strings is terminated when one of the predetermined strings is not found on completely scanning the attachment.

26. A method as claimed in claim 15, wherein step (a) comprises capturing electronic mail messages passing between a first network and a second network.

27. A method as claimed in claim 26, wherein step (a) comprises capturing electronic mail messages passing between an internal or private network and an external or public network.

28. A computer program comprising code means for performing all the steps of the method of any of claims 15 to 27 when the program is run on one or more computers.

29. A computer program as claimed in claim 28, wherein the computer program is embodied on a computer-readable medium.

30. A computer program product comprising program code means stored in a computer-readable medium for performing the method of any of claims 15 to 27 when that program product is run on one or more computers.
